(19) United States
(12) Patent Application Publication
(10) Pub. No.: US 2004/0188361 A1
(43) Pub. Date: Sep. 30, 2004

(54) Dynamic filter module

(76) Inventors: Yosei Katsu, Kanagawa (JP); Satoshi Konishi, Kanagawa (JP); Toshihiro Tanaka, Kanagawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/484,451

(22) PCT Filed: Oct. 17, 2002
(86) PCT No.: PCT/JP02/10793

(30) Foreign Application Priority Data
Oct. 18, 2001 (JP) 2001-320353

(51) Int. Cl. B01D 29/62

(52) U.S. Cl. 210/791; 210/409

(57) ABSTRACT

The present invention has an object to provide a dynamic filter module which can inhibit deterioration of the filtration flux due to deposition of sludge inside the filter to stably give good treated water. In order to achieve such an object, the present invention provides, in one embodiment, a dynamic filter module for the separation of activated sludge having a water permeable filtration layer support material for forming a dynamic filtration layer as at least part of the surrounding wall of a support whose inside is hollow, the module having the filtration section having a water permeable filtration layer for forming a dynamic filtration layer, a filtrate water outlet arranged above and/or below the filtration section, and further having a sludge collection section having a sludge discharge outlet arranged below the filtration section.

### TECHNICAL FIELD

The present invention relates to a filter module to be used in the solid-liquid separation of an activated sludge mixed liquor to be formed by the biological treatment process of wastewater, the concentration of excess sludge and the like and particularly, it relates to a filter module which can be used in the treatment of organic industrial wastewater, household effluent and the like.

### BACKGROUND ART

Heretofore, in order to obtain treated water using activated sludge, it is necessary to perform solid-liquid separation of the activated sludge. For this reason, a method of introducing activated sludge into a sedimentation tank to settle the sludge by gravity sedimentation and allowing the supernatant to flow out of the sedimentation tank has been used. However, in this method, in order to settle activated sludge, the sedimentation tank requires a sufficient sedimentation area and a sufficient residence time which have been a factor of a larger-sized treatment apparatus and an increased installment volume. Further, when the settling properties of activated sludge are deteriorated by bulking or the like, the sludge overflows the sedimentation tank to invite the deterioration of treated water.

In recent years, a technique of performing solid-liquid separation of activated sludge by membrane separation instead of the sedimentation tank is used. In this case, as the solid-liquid separation membrane, microfiltration membranes or ultrafiltration membranes are typically used. However, according to this method, suction and pressurizing by a pump are necessary as the filtration separation means, and filtration is normally performed at a pressure of several tens of kPa to several hundreds of kPa to cause high power consumption by the pump and an increase in the running cost. Further, while suspended solid (hereinafter referred to as “SS”)-free clarified treated water can be obtained by membrane separation, the permeability flux is low, and in order to prevent the membrane fouling, washing with chemicals has been periodically required.

More recently, as the activated sludge solid-liquid separation method instead of the sedimentation tank method, a method of immersing a filter composed of a water permeable sheet such as a nonwoven fabric in an aeration tank to secondarily form an adhering layer by the sludge particles as such on the surface of the filter and obtaining clarified filtrate water by a low hydraulic head pressure with the use of this sludge layer as the filtration layer is proposed. This method is called as dynamic filtration. The filter composed of a water permeable sheet as such allows sludge particles to pass, but by causing a cross flow of an activated sludge mixed liquor on the surface of the filter, a sludge froc adhering layer is secondarily formed on the water permeable sheet and this sludge layer functions as the filtration layer (dynamic filtration layer) to effect the solid-liquid separation of the sludge and SS in the liquor to be treated. The dynamic filtration layer increases its thickness with the passage of filtration time, and as a result the filtration resistance is increased to reduce the filtration flux. In this instance, the dynamic filtration layer of the sludge formed on the surface of the filter is peeled by aeration from an air diffusion pipe installed below the filter, and then by forming the dynamic filtration layer again, a stabilized filtration flux can be obtained.

However, in the solid-liquid separation of activated sludge by such dynamic filtration, sludge particles pass through the filter until a dynamic filtration layer, in other words, an activated sludge-adhering layer is formed on the surface of the filter, and thus the filtration flux is reduced due to the increase in the filtration resistance of deposited sludge inside the filter. In this instance, washing of the outer part of the filter with air by aeration from an air diffusion pipe arranged below the filter only peel the sludge layer on the surface of the filter and has no effect of discharging the deposited sludge inside the filter and, in addition, due to the intrusion of sludge into the inside of the filter from the surface thereof immediately after washing, sludge further deposits inside the filter without being discharged and as a result, the sludge inside the filter is concentrated with the passage of-treatment time to come to cause an increase in the filtration resistance, and the filtration flux is gradually reduced.

In the dynamic filtration, as the method of discharging the sludge intruded into the inside of the filter, a method of washing the inside of the filter with water by introducing treated water into the inside of the filter is known. In this case, treated water is introduced into the inside of the filter module and sludge is allowed to pass through the filtration layer outside the filtered body and part of the intruded sludge is discharged, and the remaining intruded sludge is discharged from an intake pipe (filtrate water discharge pipe) of the module simultaneously with starting of filtration. Namely, in a specified period of time after starting filtration, the sludge inside the filter is discharged without recovering filtrate water. However, in such washing of the inside of the filter with water, the wash water inlet is generally provided at only one or two places, and thus the wash water ununiformly flows into the inside of the filter and cannot uniformly discharge the sludge adhered and deposited inside the filter. Further, in discharging the washed sludge from the filtrate water discharge pipe, only the sludge positioning above the filtrate water discharge pipe is discharged and the sludge in the place remote from the filtrate water discharge pipe cannot be discharged and gradually deposits there and finally concentrates and solidifies. It is very difficult to remove the sludge once it is concentrated and solidified inside the filter.

Further, in the dynamic filtration, as another method of discharging the sludge intruded into the inside of the filter, a method of washing with air by feeding a gas (air bubbles) into the inside of the filter is known. Also in this case, the air for washing is typically introduced from the filtrate water discharge pipe, and thus the gas ununiformly flows into the inside of the filer body, and in the place where the gas is not introduced, particularly in the place where the filtrate water discharge pipe at the bottom of the filter is not arranged, sludge easily deposits to come to the factor of reduction in the filtration flux.

Furthermore, in the conventional dynamic filter module, there has been a problem of sludge deposition inside filter to clog the surface of the filtration layer, particularly in the lower part of the filter with the deposited sludge and reduction in the effective filtration surface to deteriorate the filtration flux. In addition, sometimes there has been a problem such that when sludge deposits above the filtrate water discharge pipe, the deposited sludge clogs the inlet of the discharge pipe to give none of filtrate water.

Further, in the conventional dynamic filter module, the number of the filtrate water outlet is normally one or about two, and the flow rate of the filtrate water in the place near the filtrate water outlets has been increased compared to the other place. Accordingly, there has been a problem of an increase of the deposition of sludge particles on to the dynamic filtration layer in the place where the flow rate of the filtrate water is higher and shortening of the cycle of peeling and reformation of the dynamic filtration layer.

In view of these problems in conventional methods, the present invention has been made and has an object to provide a dynamic filter module which can inhibit deterioration of the filtration flux due to the sludge deposition inside the filter to give stabilized treated water in the dynamic filtration.

### DISCLOSURE OF THE INVENTION

As the result of strenuous investigations to solve the above described problems by the present inventors, it has been found that by providing a sludge collection section below a filtration layer in the dynamic filter module to allow the sludge intruded into the filter to collect therein, stabilized filtration operation can be performed, and the present invention has been completed.

Further, it has been found by the present inventors that by allowing filtrate water to flow through rectification membranes so as to uniformly flow over the cross-sectional area of the module and being discharged, the flow of the filtrate water inside the filter can be made uniform to enable uniform utilization of the entire filtration surface, and thus stable filtration operation can be performed.

Various embodiment of the present invention which solves the above described problems are as follows.

1. A dynamic filter module for the separation of activated sludge having a water permeable filtration layer support material for forming a dynamic filtration layer as at least part of the wall surrounding a support whose inside is hollow, the module having a filtration section having the water permeable filtration layer support for forming a dynamic filtration layer, a filtrate water outlet arranged above and/or below the filtration section, and further having a sludge collection section having a sludge discharge outlet below the filtration section.

2. The dynamic filter module of the above described item 1, wherein a filtrate water collection section is arranged above and/or below the filtration section, and the filtrate water outlet is connected to the filtered waster collection section, and a filtrate water rectification members are further arranged between the filtrate water collection section and the filtration section.

3. A dynamic filter module for the separation of activated sludge having a water permeable filtration layer support material for forming a dynamic filtration layer as at least part of the wall surrounding a support whose inside is hollow, the module having a filtration section having the water permeable filtration layer support material for forming a dynamic filtration layer, and a filtrate water collection section arranged above and/or below the filtration section, a filtrate water outlet connected to the filtrate water collection section, and further having filtrate water rectification members arranged between the filtrate water collection section and the filtration section.

4. The dynamic filter module of any one of the above described items 1 to 3, wherein the filtrate water outlet is arranged above the filtration section.

5. The dynamic filter module of any one of the above described items 1 to 4, wherein a sludge agitation means is installed in the sludge collection section.

6. The dynamic filter module of the above described item 5, wherein the sludge agitation means is an air dispersion pipe.

7. The dynamic filter module of any one of the above described items 1 to 6, wherein a water inlet for washing the inside of the filter is further arranged above and/or below the filtration section.

8. The dynamic filter module of the above described item 7, wherein the water inlet for washing the inside of the filter is connected to the filtrate water collection section.

9. The dynamic filter module of the above described item 7, wherein the water inlet for washing the inside of the filter is connected to the sludge collection section.

10. The dynamic filter module of any one of the above described items 1 to 9, wherein the filtration layer support material is a woven fabric, a nonwoven fabric or a metallic net material.

11. The dynamic filter module of the above described item 10, wherein the filtration layer support material is a woven fabric, a nonwoven fabric or a metallic net material which is reinforced with a reinforcing material.

12. A process for washing and removing the sludge intruded into the inside of the dynamic filter module of any one of the above described items 1 to 11 which comprises washing the outer surface with air by aeration and the inside of the filter with air by aeration, and then introducing the water for washing the inside of the filter through filtrate water outlet or a water outlet for washing the inside of the filter into the inside of the filter, and simultaneously discharging sludge through a sludge discharge outlet.

13. The process of the above described item 12, wherein the water for washing the inside of the filter is the filtrate water obtained by the dynamic filter module.

14. The process of the above described item 12, wherein the water for washing the inside of the filter is an oxidizing agent aqueous solution.

15. The process of the above described item 13 further comprising a step of introducing an oxidizing agent aqueous solution into the inside of the filter to wash the inside of the filter after completion of washing the inside of the filter with water and discharging sludge.

In the dynamic filter module according to one embodiment of the present invention, by providing a sludge collection section below the filtration section, the sludge intruded into the inside of the filter is collected by gravity sedimentation in the sludge collection section and is discharged outside through a sludge discharge outlet until a dynamic filtration layer is formed on the surface of a filtration layer support material. Thus, adhesion of the sludge intruded into the inside of the filter to the inside of the filter and its deposition therein can be prevented to solve the problem of reduction in the filtration area caused by deposition, concentration and solidification of the intruded sludge and the resulting deterioration of the filtration flux, and a stabilized amount of filtrate water can be obtained.

Further, according to a more preferred embodiment of the present invention, by installing a sludge agitation means in the sludge collection section, the sludge inside the sludge collection section and inside the filter is periodically agitated and dispersed, and thus the sludge can be discharged without adhesion and deposition as well as concentration and solidification inside the filter and the sludge collection section through the sludge discharge outlet without resistance at a stabilized flow rate. The sludge agitation means can preferably be arranged at the place where sludge easily deposits in the sludge collection section, and the place can be determined empirically by a person with ordinary skill in the art or by a preliminary experiment.

As the sludge agitation means, various mechanical agitation means which are known in the art can be used, but an air diffusion pipe is preferably used. In this instance, by the aeration from this air diffusion pipe, the sludge inside the sludge collection section is agitated. Moreover, when the air diffusion pipe is used, air bubbles from the sludge collection section rise inside the filter on aeration to agitate the inside of the filter by a gas-liquid mixture, and the sludge adhering to the inside of the filter can also be peeled. Accordingly, the air diffusion pipe is preferably arranged so as to allow air bubbles to uniformly rise inside the filter on aeration. As far as the present inventors know, there is no example in the conventional dynamic filter module in which an air diffusion pipe is arranged inside the filter.

The dynamic filter module according to another embodiment of the present invention is characterized by arranging a filtrate water collection section connected to a filtrate water outlet above and/or below the filtration section and installing filtrate water rectification members between the filtrate water collection section and the filtration section. The filtrate water rectification members means herein the ones that allow the filtrate water flowing from the filtration section to uniformly pass over the entire cross-sectional area of the water collection section and, for example, the filtrate water rectification members can be constituted by arranging a number of communicating holes over the entire cross-sectional area. In the conventional dynamic filter module in which such filtrate water rectification members are not arranged, the filtrate water flows more quickly in the place near the filtrate water outlet, and thus the flow of the filtrate water inside the filter becomes ununiform to render uniform filtration on the entire filtration surface impossible, and sludge has quickly deposited at the place where the filtrate water flows quickly. According to such an embodiment of the present invention, this problem is solved by installing filtrate water rectification members, and the filtrate water is allowed to uniformly flow inside the filter and the progression of filtration can uniformly proceed on the entire filtration surface and as result, the frequency of peeling and reformation of the dynamic filtration layer could have been reduced. Further, by providing these rectification members also in the place where the water for washing the inside of the filter is introduced in the same manner, washing water can be uniformly introduced into the inside of the filter in washing the inside of the filter with water, and thus the entire sludge inside the filter can be washed.

Further, it is preferred that by simultaneously possessing the above explained two constitutional elements, a dynamic filter module which enables more stabilized filtration operation can be obtained.

In the dynamic filter module according to the present invention, the filtrate water outlet and the filtrate water collection section can be arranged above and/or below the filtration section where the filtration layer is provided, but they are more preferably arranged above the filtration section. By arranging the filtrate water outlet and the filtrate water collection section above the filtration section and, simultaneously, arranging the sludge collection section below the filtration section, the filtrate water may be taken out from upper portion while settling the sludge intruded into the inside of the filter downwards by gravity sedimentation even during the filtration operation, and thus filtrate water of good quality with reduced inclusion of sludge can be obtained.

### BRIEF EXPLANATION OF THE DRAWINGS

FIG. 1 is a flow sheet of one concrete example of the system for performing the biological treatment of sewage with the use of a dynamic filter module of the present invention.

FIG. 2 is a diagram showing one concrete example of the dynamic filter module according to the present invention; FIG. 2(a) is a front view and FIG. 2(b) is a side cross-sectional view.

FIG. 3 is a graph showing the relationship between the number of days with the progression of the filtration operation and the average filtration flux.

In each drawing, the reference number has the following meaning.

Numeral 1 is influent raw water; numeral 2 is a biological treatment tank; numeral 3 is a sludge mixed liquor feed pump; numeral 4 is a filtration separation tank; numeral 5 is an air diffusion pipe for washing the outer surface of a filter with air; numeral 6 is a dynamic filter module; numeral 7 is a filtrate water valve; numeral 8 is an air vent valve; numeral 9 is a valve for washing air; numeral 10 is a valve for air for washing the inside of the filter; numeral 11 is a sludge discharge valve; numeral 12 is a blower for washing air; numeral 13 is a treated water tank; numeral 14 is a pump for water for washing the inside of the filter; numeral 15 is a filtrate water line; numeral 16 is a line for water for washing the inside of the filter; numeral 17 is a sludge discharge line; numeral 18 is a circulating sludge mixed liquor; numeral 19 is treated water; numeral 21 is a filter support; numeral 22 is a pressure plate; numeral 23 is a woven fabric; numeral 24 is an inner support pillar; numeral 25 is a support spacer; numeral 26 is a support net; numeral 27 is a filtrate water outlet; numeral 28 is a water inlet for washing the inside of the filter; numeral 29 is a sludge discharge outlet; numeral 30 is a sludge collection section; numeral 31 is a filtrate water rectification member; numeral 33 is a pipe for diffusing air into the inside of the filter; numeral 34 is an air feed pipe; and numeral 35 is a filtrate water collection section.

### BEST MODE FOR CARRYING OUT THE BEST MODE OF THE INVENTION

A preferred embodiment of the present invention will now be explained by reference to the Drawings. However, the following explanation is to explain one concrete example which embodies the technical thought of the present invention and the present invention is not to be limited to this explanation.

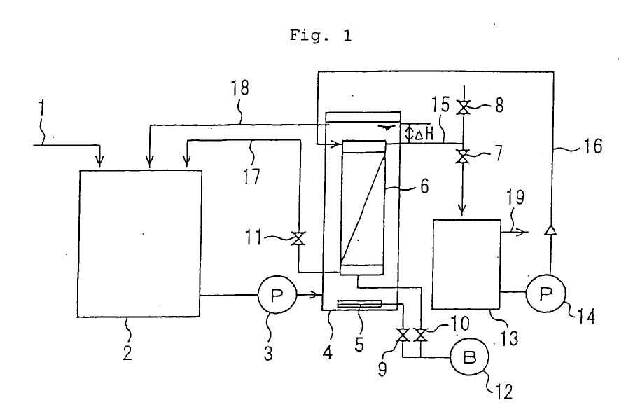

FIG. 1 is a flow sheet of the system for performing the biological treatment of sewage with the use of a dynamic filter module of the present invention. Influent raw water (sewage to be treated) 1 flows into a biological treatment tank 2 and the anaerobic treatment of activated sludge is performed in the biological treatment tank 2. Activated sludge mixed liquor is discharged from the biological treatment tank 2 and fed to a filtration separation tank 4 by a sludge mixed liquor feed pump 3. The activated sludge mixed liquor flowed into the filtration separation tank 4 is filtered by a dynamic filter module 6 by a hydraulic head pressure of AH, and filtrate water is obtained through a filtrate water line 15, and then allowed to flow into a treated water tank 13 through a treated water valve 7. The treated water 19 is obtained from the treated water tank 13. Further, the sludge mixed liquor after filtration treatment is returned to the biological treatment tank 2 as a circulating sludge mixed liquor 18.

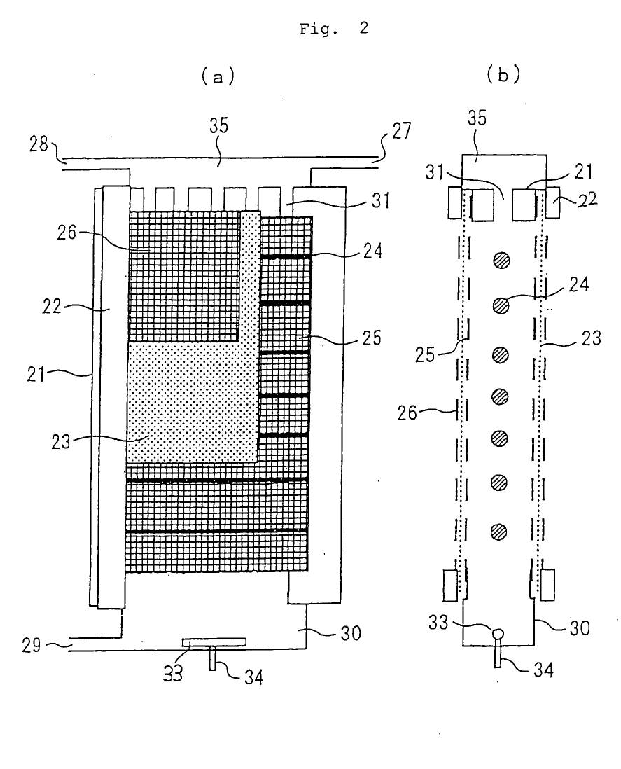

Next, a concrete constitution example of the dynamic filter module according to the present invention is shown in FIG. 2. FIG. 2(a) shows a front view of the structure of the filter module and FIG. 2(b) shows its side cross-sectional view. The dynamic filter module according to one embodiment of the present invention as shown in FIG. 2 has a filter support 21 whose inside is hollow and a filtration layer support material constituting at least part of the surrounding wall of the filter support. Concretely, at least part of the surrounding wall of the filter support 21 is opened, and the opened portion is covered with a filtration layer support material.

As the filtration layer support material, any of nonwoven fabrics, woven fabrics, metallic net materials and the like which are known as the support materials for forming a dynamic filtration layer may be used. Further, as shown in FIG. 2, the filter layer support material is preferably constituted by applying, for example, a woven fabric 23 to a support spacer 25, superposing a support net 26 on the woven fabric, and fixing the support net with a pressure plate 22. By reinforcing the filtration layer support with an reinforcing material such as the support spacer and the support net, such a phenomenon that the filtration layer support material such as the woven fabric is inwardly deflected during filtration or the filtration layer support material is outwardly deflected when the surface of the filtration layer is washed with air or the inside of the filter is washed with water can be inhibited, and thus the deformation of the filtration layer support material is prevented to endure in long-term use. Furthermore, compared to the use of a woven fabric or a nonwoven fabric alone, the surface of the filter layer material is always flat without the expansion and contraction of the surface of the filtration layer support material, and accordingly a uniform dynamic filtration layer can be formed over the entire surface of the filtration layer support to give a stabilized filtration flux. As the support spacer 25 to be arranged on the inner side of the woven fabric or the like, it is preferred to use a net member having an aperture of 5 to 50 mm, preferably 5 to 25 mm from the viewpoint of the function which allows sludge particles and sludge frocs to sufficiently pass through and, simultaneously, prevents the deflection of the woven fabric, the nonwoven fabric or the like to be held therewith. Further, the support net 26 which is arranged on the outer side of the woven fabric or the like preferably has an aperture of not smaller than 10 mm so as to inhibit expansion of the woven fabric or the like and not to cause deposition of sludge between the support net 26 and the woven fabric or the like. Further, the reinforcing material 26 which is arranged on the outer side of the woven fabric or the like may also be constituted of a support member obtained by crossing bar members with each other to form a lattice instead of the netlike member.

In addition, in order to reinforce the inside of the filter support, it is preferred to install inner support pillars 24.

In the dynamic filter module as shown in FIG. 2, a filtrate water collection section 35 is arranged above a filtration section to be formed by the filtration layer support material and, simultaneously, filtrate water rectification members to be formed by filtrate water communicating holes 31 are arranged between the filtrate water collection section 35 and the filtration section. Further, a filtrate water outlet 27 and an inlet for the water for washing the inside of the filter are connected to the filtrate water collection section 35, respectively. By this constitution, the filtrate water filtered by the dynamic filtration layer is rectified through the communicating holes 31, allowed to flow into the filtrate water collection section 35, and then discharged from the filtrate water outlet 27. Thus, the flow of the filtrate water in the filter becomes uniform to enable using whole of the filtration layer uniformly over its entire surface.

Furthermore, below the filtration section, a sludge collection section 30 connected to a sludge discharge outlet 29 is arranged and a pipe 33 for diffusing air into the inside of the filter connected to an air feed pipe 34 is arranged in the sludge collection section 30.

Next, the method of operating the above explained dynamic filter module will be explained by reference to FIG. 1 and FIG. 2.

The dynamic filter module according to the present invention as shown in FIG. 2 is installed in the filtration separation tank 4 as shown in FIG. 1 to form a cross flow stream of a sludge mixed liquid in the filtration separation tank 4. By this stream, a dynamic filtration layer of sludge floc particles is formed on the filtration support material. The filtrate water outlet 27 and the water inlet 28 for washing the inside of the filter of the filter module are closed and the sludge discharge outlet 29 is opened until the dynamic filtration layer is formed, whereby the sludge intruded into the inside of the filter is discharged from the sludge discharge outlet 29. The sludge discharge outlet 29 is connected to a sludge discharge line 17 as shown in FIG. 1, and the discharged sludge is returned to the biological treatment tank 2.

Once the dynamic filtration layer is formed on the filtration layer support material, the sludge discharge outlet 29 is closed and the filtrate water outlet 27 is opened to discharge the filtrate water filtered by the dynamic filtration layer through the filtrate water outlet 27 by the hydraulic head pressure (ΔH in FIG. 1). The filtrate water outlet 27 is connected to the filtrate water line 15 as shown in FIG. 1, and the filtrate water is introduced into the treated water tank 13. In this instance, in the dynamic filter module according to a preferred embodiment of the present invention as shown in FIG. 2, the filtrate water collection section is arranged above the filtration section through the filtrate water rectification members 31, and thus the filtrate water passed through the dynamic filtration layer is allowed to uniformly flow into the collection section over the entire cross-section. Thus, the flow of the filtrate water inside the filter is uniform, and the recycle of peeling and reformation of the dynamic filtration layer can be more prolonged.

After continuing the filtration operation for a specified period of time, peeling and reformation of the dynamic filtration layer and removal of the sludge intruded into the inside of the filter are performed. In the dynamic filter module according to the present invention, by washing the surface of the dynamic filtration layer with air and the inside of the filter with air, and successively washing the inside of the filter with water and discharging sludge, the intruded sludge can be more efficiently washed and removed.

First, washing of the surface of the dynamic filtration layer with air (washing of the outer part of the filter with air) can be performed by aeration from a diffusion pipe 5 for washing air installed in the filtration separation tank. As to washing of the inside of the filer body with air, by closing an air valve 9, opening a valve 10 for air for washing the inside of the filter, and feeding air from a blower 12 for washing air to aerate through an air feed pipe 24 and a pipe 33 for diffusing air into the inside of the filter, the sludge present in the sludge collection section 30 is agitated, and simultaneously the inside of the filter is washed with air. The introduced air is discharged through the filtrate water outlet, and discharged to the air by opening an air vent valve 8. Either of the operation of washing the surface of the filtration layer with air (washing the outer part of the filter with air) and that of washing the inside of the filter with air may be performed earlier or both operations may be simultaneously performed.

After completion of washing the outer part and the inside of the filtration body with air, the aeration from the pipe 33 for diffusing air into the inside of the filter is stopped and the filtrate water outlet 27 is closed, and an water inlet 28 for washing the inside of the filtered body is opened to introduce water for washing the inside of the filter into the inside of the filter. Washing of the inside of the filter with water is preferably performed immediately after the above described washing with air or 0.5 to 5 minutes after the washing with air. By washing the inside of the filter with water, part of the sludge intruded into the inside of the filter passes through the filtration layer and is discharged out of the filter, and the remaining sludge is discharged from the sludge discharge outlet 29. The sludge discharged from the sludge discharge outlet 29 is returned to the biological treatment tank 2 through the sludge discharge line 17 and the sludge discharge valve 11 as shown in FIG. 1. When discharge of the sludge is conducted simultaneously with washing of the inside of the filter with water, the sludge intruded into the inside of the filter can be discharged together with the water for washing the inside of the filter to preferably reduce deposition of the intruded sludge, but the sludge can be also discharged after completion of washing the inside of the filter with water. The timing of the sludge discharge can be determined by opening the sludge discharge valve 29. It is preferred to further continue the discharge of sludge for about several minutes after stopping washing the inside of the filter with water. Namely, it is preferred that even after completion of the above described washing operation and starting filtration operation, the filtrate water is discharged as the sludge mixed liquor through the sludge discharge outlet 29 without being recovered for about several minutes. In the mode of the dynamic filter module as shown in FIG. 2, the water inlet for washing the inside of the filter is connected to the outer side of the filtrate water rectification members as the filtrate water outlet is and the water for washing the inside of the filter is introduced into the inside of the filter through the filtrate water rectification members. By using such a mode, the flow rate of the water for washing the inside of the filter in the horizontal direction of the inside of the filter becomes uniform to enable completely washing the sludge adhering to the inner surface of the filter. Further, in the mode of the dynamic filter module as shown in FIG. 2, a water inlet 28 for washing the inside of the filter is provided separately from the filtrate water outlet 27 but the filtrate water outlet 27 can be also used as the water inlet for washing the inside of the filter. In addition, the water for washing the inside of the filter can be fed to the inside of the filter through the sludge collection section below the filtration section.

When clarified water having a low concentration of SS and a low turbidity is used as the water for washing the inside of the filter, the sludge inside the filter is diluted and easily discharged outside. The filtrate water through the dynamic filter module normally has a turbidity of not higher than 10 degrees and a concentration of SS of not higher than 10 mg/L and can accordingly be used as the water for washing the inside of the filter. Accordingly, as shown in FIG. 1, it is preferred that the filtrate water obtained from the filter module is stored in a treated water tank 13, and then its part is fed to the water inlet (numeral 28 in FIG. 2) for washing the inside of the filter through a water line 16 for washing the inside of the filter by a pump 14 for the water for washing the inside of the filter. Further, the treated water obtained by further subjecting the filtrate water from the dynamic filter module to filtration treatment by sand filtration or MF membrane filtration contains almost no SS, and thus is more preferably used as the water for washing the inside of the filter. Moreover, an aqueous solution of an oxidizing agent such as sodium hypochlorite also enables removal of biological slime as well and is preferred as the water for washing the inside of the filter module since a more enhanced effect is expected. When the solution of an oxidizing agent such as sodium hypochlorite is used as the water for washing the inside of the filter, it is preferred to introduce the oxidizing agent solution into the inside of the filter to wash the inside of the filter after completion of a series of the above described process of air washing—water washing of the inside of the filter—sludge discharge.

After completion of a series of this washing-sludge discharge process, formation of the dynamic filtration layer and filtration operation as mentioned above are performed again. The frequency of performing this series of washing operations greatly varies depending on the properties of the sludge mixed liquor to be treated and the like, and typically it is preferred that the washing operation is preferably performed at a frequency of once every two to four hours.

In FIG. 2, a mode of providing the filtrate water outlet 27 above the filtration section is shown, but the filtrate water can be also taken out from the bottom of the filter module. In this instance, by providing a piping and a change-over valve, the sludge discharge outlet 29 may be used as the filtrate water outlet and the filtrate water can be taken out therefrom during the filtration operation. Further, the filtrate water outlet can be also provided below the filter section separately from the sludge discharge outlet 29.

The sludge mixed liquor which can be filtered and separated by the filter module according to the present invention may include any of an activated sludge mixed liquor, a coagulated sludge mixed liquor, a preliminarily settled sludge mixed liquor and the like. Further, the dynamic filter module of the present invention can be also used as an solid-liquid separator for wastewater having a high concentration of SS, river water and the like.

The present invention will now be concretely explained by an example, provided that the present invention is not to be limited to the following example.

### EXAMPLE 1

With the use of the dynamic filter module as shown in FIG. 2, the solid-liquid separation treatment of the activated sludge mixed liquor obtained from the activated sludge treatment system of housing complex sewage was performed.

As the support material for forming the dynamic filtration layer thereon, the one composed of two sheets of polyethylene nets having an-aperture of 10 mm and a thickness of 2.0 mm sandwiching a polyester woven fabric having a thickness of about 0.1 mm and a pore diameter of 114 μm therebetween was used. Five plane filter modules having an effective area of 1 m² per sheet were arranged immersed in the filtration separation tank. The hydraulic head pressure during filtration was set at about 10 dc, and the cross flow velocity on the filter surface of the sludge mixed liquor was set at 0.025 m/s in average.

Every two hours of the filtration operation, washing operation of air washing of the outer part of the filtration body—air washing of the inside of the filtration body—water washing of the inside of the filtration body and discharge of sludge was performed. Various conditions of the washing operation are shown in FIG. 1.

TABLE 1
Conditions of Washing Filter Module

| | |
|---|---|
| Amount of Air for Washing Outer Part of Filter | 2.5 |
| m³/m²/min* | |
| Time for Washing Outer Part of Filter with Air | 3.0 |
| min | |
| Amount of Air for Washing Inside of Filter | 1.7 |
| m³/m²/min* | |
| Time for Washing Inside of Filter with Air | 1 |
| min | |
| Amount of Water for Washing Inside of Filter | 40 |
| m³/m²/d** | |
| Time for Washing Inside of Filter with Water | 0.5 |
| min | |
| Time for Discharging Sludge min | 3 |
| Filtration/Washing Intervals | once every |
| | 2.0 h |

*Amount of air for washing: Amount of air per cross-sectional area of the flow passage in the filter
**Amount of water for washing the inside of the filter: Amount of water per effective filtration area

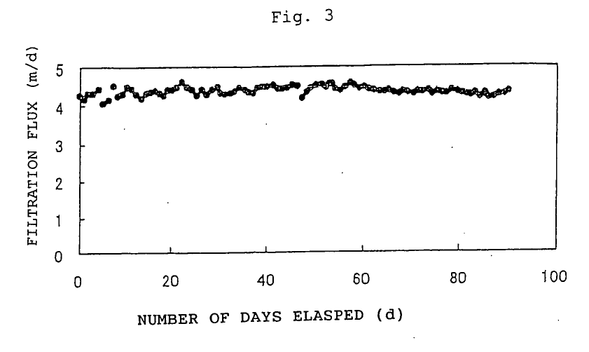

In FIG. 3, the filtration flux with the passage of time in the present Example is shown.

During the operation of about three months after starting the treatment, a stabilized treatment with a filtration flux of about 4 m/d or more was obtained.

### Industrial Applicability

According to the present invention, by providing a sludge collection section below the filtration section of a dynamic filtration body module, the sludge intruded into the inside of the filter until a dynamic filter layer is formed is collected in the sludge collection section by gravity sedimentation, and is discharged out through a sludge discharge outlet. Thus, the sludge intruded into the inside of the filter can be prevented from adhering to the inside of the filter and depositing therein to solve the problem of reduction of the effective filtration area and deterioration of the filtration flux accompanied by, in the filter, the deposition/concentration/solidification of the sludge intruded into the filer body, and a stabilized amount of treated water can be obtained.

Further, in a more preferred embodiment of the present invention, by installing a sludge agitation means in the sludge collection section and periodically agitating and dispersing the sludge in the sludge collection section by this sludge agitation means, the sludge in the sludge collection section and the inside of the filter neither concentrates and solidifies nor adheres and deposits and can be discharged through the sludge outlet at a stabilized flow rate without resistance. Moreover, when the aeration by an air diffusion pipe is used as the sludge agitation means, air bubbles from the sludge collection section rise on aeration to effect inner agitation by a gas-liquid mixture inside the filter, and thus the adhering sludge inside the filter can be more efficiently peeled.

As a result, deterioration of the filtration flux due to the deposition of sludge inside the filter can be inhibited to give stabilized treated water.

In addition, in another embodiment of the present invention, by providing a treated water collection section above and/or below the filtration section and installing filtrate water rectification means between the filtrate water collection section and the filtration section, the flow of the filtrate water inside the filter becomes uniform to enable uniform filtration over the entire filtration area. Further, when the water for washing is fed into the inside of the filter on washing the inside of the filter with water, the flow rate of the water for washing the inside of the filter in the horizontal direction of the inside of the filter becomes uniform and the sludge adhering to the inner surface of the filter can be completely washed out.

1-15 (Cancelled)

16. A dynamic filter module for the separation of activated sludge having a water permeable filtration layer support material for forming a dynamic filtration layer as at least part of the wall surrounding a support whose inside is hollow, the module having a filtration section having the water permeable filtration layer support material for forming a dynamic filtration layer, a filtrate water outlet arranged above and/or below the filtration section, and further having a sludge collection section having a sludge discharge outlet below the filtration section.

17. The dynamic filter module of claim 16, wherein a filtrate water collection section is arranged above and/or below the filtration section and the filtrate water outlet is connected to the filtrate water collection section, and filtrate water rectification members are further arranged between the filtrate water collection section and the filtration section.

18. A dynamic filter module for the separation of activated sludge having a water permeable filtration layer support material for forming a dynamic filtration layer as at least part of the wall surrounding a support whose inside is hollow, the module having a filtration section having the water permeable filtration layer support material for forming a dynamic filtration layer, and a filtrate water collection section arranged above and/or below the filtration section, a filtrate water outlet connected to the filtrate water collection section, and further having filtrate water rectification members arranged between the filtrate water collection section and the filtration section.

19. The dynamic filter module of claim 16, wherein the filtrate water outlet is arranged above the filtration section.

20. The dynamic filter module of claim 16, wherein a sludge agitation means is installed in the sludge collection section.

21. The dynamic filter module of claim 20, wherein the sludge agitation means is an air dispersion pipe.

22. The dynamic filter module of claim 16, wherein a water inlet for washing the inside of the filter is further arranged above and/or below the filtration section.

23. The dynamic filter module of claim 22, wherein the water inlet for washing the inside of the filter is connected to the filtrate water collection section.

24. The dynamic filter module of claim 22, wherein the water inlet for washing the inside of the filter is connected to the sludge collection section.

25. The dynamic filter module of claim 16, wherein the filtration layer support material is a woven fabric, a nonwoven fabric or a metallic net material.

26. The dynamic filter module of claim 25: wherein the filtration layer support material is a woven fabric, a nonwoven fabric or a metallic net material which is reinforced with a reinforcing material.

27. The dynamic filter module of claim 18, wherein the filtrate water outlet is arranged above the filtration section.

28. The dynamic filter module of claim 18, wherein a sludge agitation means is installed in the sludge collection section.

29. The dynamic filter module of claim 28, wherein the sludge agitation means is an air dispersion pipe.

30. The dynamic filter module of claim 18, wherein a water inlet for washing the inside of the filter is further arranged above and/or below the filtration section.

31. The dynamic filter module of claim 30, wherein the water inlet for washing the inside of the filter is connected to the filtrate water collection section.

32. The dynamic filter module of claim 30, wherein the water inlet for washing the inside of the filter is connected to the sludge collection section.

33. The dynamic filter module of claim 18, wherein the filtration layer support material is a woven fabric, a nonwoven fabric or a metallic net material.

34. The dynamic filter module of claim 33, wherein the filtration layer support material is a woven fabric, a nonwoven fabric or a metallic net material which is reinforced with a reinforcing material.

35. A process for washing and removing the sludge intruded into the inside of the dynamic filter module of claim 16 which comprises washing the outer surface with air by aeration and the inside of the filter with air by aeration, and then introducing the water for washing the inside of the filter through a filtrate water outlet or a water inlet for washing the inside of the filter into the inside of the filter, and simultaneously discharging sludge through a sludge discharge outlet.

36. The process of claim 35, wherein the water for washing the inside of the filter is the filtrate water obtained by the dynamic filter module.

37. The process of claim 35, wherein the water for washing the inside of the filter is an oxidizing agent aqueous solution.

38. The process of claim 35 further comprising a step of introducing an oxidizing agent aqueous solution into the inside of the filter to wash the inside of the filter after completion of washing the inside of the filter with water and discharging sludge.
